(19) United States
(12) Patent Application Publication
(10) Pub. No.: US 2004/0064995 A1
(43) Pub. Date: Apr. 8, 2004

(54) Animal lure scent solution, dispenser and method

(76) Inventor: Lance F. Gilmore, Livonia, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/266,144

(22) Filed: Oct. 7, 2002

(51) Int. Cl. A01M 1/00

(52) U.S. Cl. 43/1

(57) ABSTRACT

The animal lure scent solution and the dispenser containing the solution is for attracting a species of deer in the deer family. The attractant solution comprises approximately one-third by volume of an attractant scent and approximately two-thirds by volume of a scentless liquid bubble soap which forms a carrier for the attractant scent when mixed with the carrier to form the animal lure scent solution. The solution is released into the atmosphere by blowing air on the bubble solution with the result that bubbles containing the attractant scent are formed which travel with the airflow and break on tree limbs, surrounding bushes, vegetation on the ground for the purpose of attracting a species of deer.

### BACKGROUND OF THE INVENTION

1. Field of the Invention

The present invention relates generally to an animal lure scent solution, dispenser and method or procedure for dispensing or releasing into the air a scent encapsulated in a carrier formed by a scentless liquid bubble soap for use in a attracting a species of animal in the deer family, including whitetail deer, mule deer, elk, caribou and moose.

2. Description of the Related Art

The use of scents or lures to attract animals is well known. The use of deer scents such as doe urine to attract deer, particularly bucks, has become more popular in recent years. While baiting game animals is generally illegal, the use of scents is allowed. Such scents are dispensed in a number of ways. Often times a hunter will use it on his or her clothing to mask the natural odors. Other times it is distributed at a site to attract game to that location. Numerous patents have been issued on game or deer scent dispensing or diffusion systems and such prior art devices are primarily of three types. The first type of device drips deer scent on the ground. The second type employs a heater to aid in diffusing the scent and another type of device employs a wick or other absorbent material. Each of the prior art devices fail to address a problem and that it is of dispersing the scent throughout a wide area without alerting the deer to the fact that a hunter is present in the vicinity.

The present invention utilizes a scentless liquid bubble soap to encapsulate the attractant scent of various types in liquid or particle form within the bubbles and to disperse the bubbles by blowing on the solution or scent fluid with the use of an applicator to distribute the bubbles via the airflow in the environment where the bubbles will break on tree limbs, surrounding bushes, vegetation and the ground where the bubbles burst to release the attractive scent to the surrounding area to attract a specie of deer.

### SUMMARY OF THE INVENTION

Accordingly, it is a primary feature of the present invention to provide an animal attractant scent fluid or solution, dispenser and method that are able to provide a continuous supply of a bubble encapsulated scent for extended periods of time.

Another feature of the present invention is to provide an animal attractant scent solution, dispenser and method for diffusing the bubble encapsulated scent to the air currents in the vicinity for attracting game in an easy and efficient manner.

A further feature of the present invention is to provide an animal attractant scent fluid or solution, dispenser and method that are simple to use, effective in diffusing the scent and in attracting game by airborne currents while reducing waste of the scent solution.

A still further feature of the present invention is to provide an animal attractant scent dispenser which is not bulky or cumbersome to carry and may be carried in the pocket of the hunter.

Another feature of the present invention is to provide an animal attractant scent dispenser which is light weight and utilizes air flow and ambient air currents to diffuse the scent.

Still another feature of the present invention is to provide a scent dispensing system that is compact in size and is economical to manufacture.

The animal lure scent fluid or solution comprises approximately one-third by volume of an attractant scent fluid and approximately two-thirds by volume of a scentless liquid bubble soap which forms a carrier for the attractant scent fluid when mixed with the carrier to form the solution, with the solution being released into the atmosphere by blowing air onto the bubble solution with the results that the bubbles containing the attractant scent travel with the airflow in the environment and break on tree limbs, surrounding bushes, vegetation in the ground to attract a species of the deer.

The attractant scent fluid utilized in the animal lure scent solution may be a liquid scent or relatively small particles of dirt or earth which has a non-offensive odor when used and serves as a cover up and presents a mild anus smell that will not be offensive to the deer being pursued by the hunter. The attractant liquid scent may be either liquid urine, urine from a female doe, male buck or an estrus doe.

In other cases, the animal lure scent fluid or solution may contain an attractant liquid scent made from fruits and vegetables providing a non-offensive odor such as corn, soy beans, apples, pears, carrots, sugar beets, acorns, mulberries, licorice or anus. Such attractant scents provides a cover for humans, preventing the human scent from drifting into the area where the deer are located. A molasses scent and a vanilla extract may also be used with the scentless liquid bubble soap.

### BRIEF DESCRIPTION OF THE DRAWINGS

FIG. 1 is a front fragmentary view of a forest, showing a hunter in a tree stand having dispensed the attractant scent carrying bubbles into the forest via the airflow where the bubbles break on tree limbs, surrounding bushes, vegetation and ground to attract a specie of animal in the deer family.

FIG. 2 is an exploded view of the animal lure scent dispenser showing the container, cap and stem.

### DETAILED DESCRIPTION OF THE PREFERRED EMBODIMENT

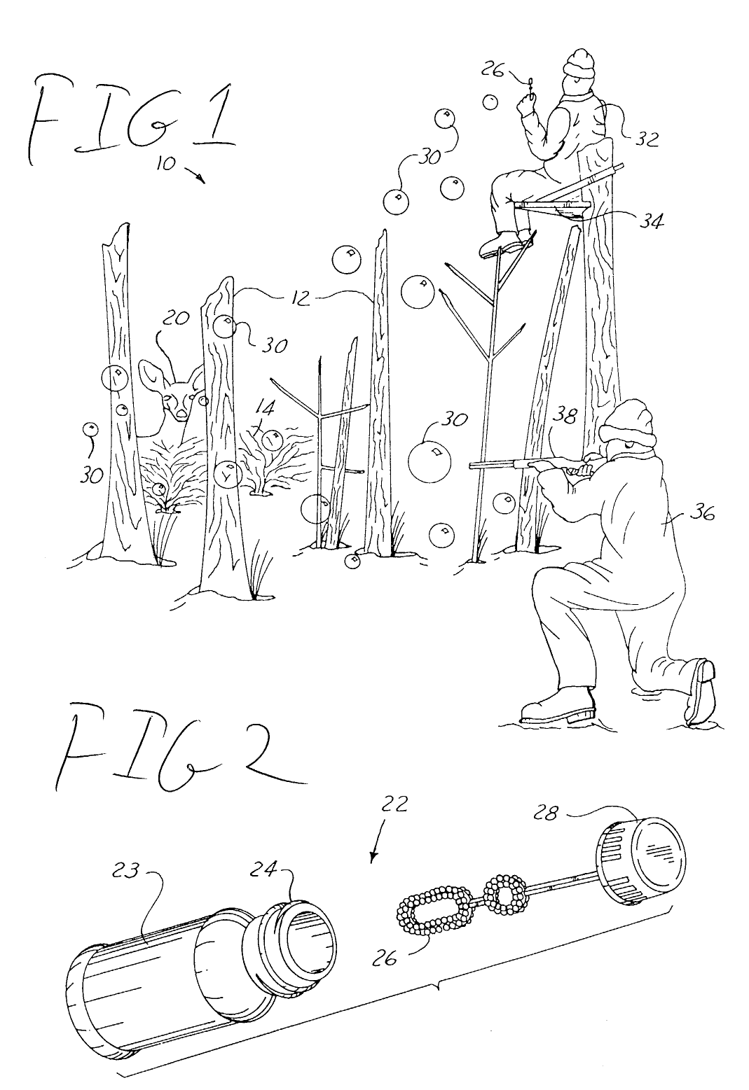

FIG. 1 of the patent drawing schematically shows a forest 10 containing trees 12, tree limbs and vegetation 14 and constitutes the environment which is attractive to white tail deer, mule deer, elk, caribou and even moose. There are a number of attracting scents on the market which are designed to bring wild game into close range. The application of these products in most cases are not effective in attracting the deer. Small spray bottles are used which are noise. Spillage of the deer scent also occurs. The scent of the prior art devices have a limited range of travel.

The present invention improves on existing methods and systems for attracting deer. There are a number of attractant scents for deer's which may be utilized including urine taken from a specie of the deer family or from a female doe or male buck or a doe estrus. In addition, attractant scents commercially available are in the form of dirt or earth scents which have a non-offensive odor. Also, attractive scents may be made from fruits or vegetables providing a non-offensive odor such as corn, soybeans, apples, pears, carrots, sugar beets, acorns, and mulberries, to name a few. In addition, molasses scent and vanilla scent may be use with the present invention. Regardless of the scent selected, the scent is mixed with an unscented soap bubble solution. The animal scent solution of the present comprises approximately one-third by volume of an attractant scent and approximately two-third by volume by a scentless liquid bubble soap which forms a carrier for the attractant scent when mixed with the carrier to form the animal lure scent solution. The solution when released into the air by blowing air on the bubble solution results in that bubbles being formed containing the attractant scent which travel anywhere from twenty feet to sixty feet with the airflow and break on tree limbs, surrounding bushes, vegetation and the ground for the purpose of attracting a species of deer 20 as shown in FIG. 1.

The attractant scent and the scentless bubble solution are mixed together and are placed generally in a dispenser 22 of one ounce capacity. The bottle or container 23, made from a plastic material, has a threaded end 24 in which is inserted the stem or applicator 26 attached at one end to the bottle cap 28 which is screw threaded onto the container 23. The resulting product is used primarily during the mating season of the animals and is used primarily to attract the male animal of the species being pursued.

The product is released or dispensed into the air by removing the bubble applicator 26 from the solution in the container 23 and blowing on applicator 26. By doing this, the bubbles 30 will travel with the air flow and break on tree limbs and the ground and disburse the scent in the air. The product may be dispensed as illustrated in FIG. 1 by a hunter 32 in a tree stand 34 or by a hunter on the ground.

Urine from a doe in heat may form an attractant scent and when mixed thoroughly with scentless bubble soap solution forms a product which can be used primarily during the mating season of the animals in the deer family and is used primarily to attract the male animal of the species. Doe estrus products that can be used are Tinks 69, Prime Time Estrus Plus or any estrus attracting scent.

When doe urine is utilized, it can be used as an attractant scent as well as a cover-up when mixed with the scentless bubble solution and will provide a cover-up for human scent and prevent the animal from detecting the human. The smell of the urine will not be offensive to the animal being hunted and will also assist in the attraction of the animal. Doe urine products which are used include Prime Time Natural doe urine, Tinks doe urine, to name a few.

When urine taken from a buck is utilized, the resulting product can be an attractant as well as a cover-up. The same formula as mentioned above is utilized, namely, one-third of an ounce of buck urine is mixed with two-thirds of an ounce of unscented bubble solution.

Commercially available is a product for “All Seasons” which provides an attractant scent which is used primarily as a cover-up of non-offensive odors. One-third of an ounce of the “All Season” product is mixed with two-third of an ounce of the scentless bubble soap solution. The “All Season” product has a mild anus smell that is not offensive to the deer being pursued.

A commercially available earth scent is used primarily as a cover-up scent. One-third of an ounce of earth scent is mixed with two-thirds of an ounce of scentless bubble solution. The resulting product can be used in a tree stand or while walking to cover-up human scent as well as to cover-up the scent drifting into the woods. Once commercially available earth scent product is called Wildlife Research Center earth scent.

Favorable results have been obtained by utilizing the various attractive scent products combined with the scentless bubble soap solution. The resulting animal lure scent products float with the wind and most animal travel upwind for that reason to detect favorable or unfavorable spells or dangers. The use of a scentless bubble soap solution as a carrier for the attractant scent permits the hunter to dispense the product from a tree stand 34 without alerting or attracting the deer to his or her location.

Once the product evaporates, the hunter does not have to get out of the tree stand 34 to administer another application; he or she just simply removes the bottle 23 containing the attractant solution from his or her pocket, blows on the applicator 26 and directs bubbles 30 into the air of the forest 10. As a result thereof, the bubbles 30 travel anywhere from twenty to sixty feet from the tree stand 34 and will land or break on trees 12, tree limbs, bushes, vegetations 14 and so forth without making any noise which could scare off any deer's and further without adding any human scent to the environment.

The animal lure scent solution and the corresponding animal attractant scent dispenser 22 and method are conveniently used. The dispenser 22 permits the hunter 32 to carry it in his or her pocket. A second hunter 36 has a rifle 38 which is aimed at deer 20 of FIG. 1.

From the foregoing, it should be recognized that the method and the dispenser 22 have been advantageously provided herein enabling a hunter to selectively dispense a scent for use in hunting without coming into physical contact with the scent liquid and which does not experience unwanted evaporation prior to use. The dispenser 22 in accordance with the aforementioned invention can be manufactured economically from various readily available materials and may be disposed of in a trouble-free and expedient manner so as to maintain the nature beauty of the hunting grounds following use.

The foregoing description is included to describe several embodiments of the present invention and is not meant to limit the scope of the invention. From the foregoing description, many variations would be apparent to those skilled in the art that would be encompassed by the spirit and scope of the invention as described above.

What is claimed is:

1. An animal lure scent solution for attracting a specie of deer in the deer family including white tail deer, mule deer, elk, caribou and moose; said solution comprising approximately ⅓ by volume of an attractant scent and approximately ⅔ by volume of a scentless liquid bubble soap which forms a carrier for the attractant scent when mixed with said carrier to form said solution; said solution being released into the atmosphere by blowing air on the bubble solution, with the result that bubbles containing the attractant scent are formed which travel with the air flow and break on tree limbs, surrounding bushes, vegetation and the ground for the purpose of attracting a specie of deer.

2. The animal lure scent solution of claim 1, wherein said attractant scent is a liquid.

3. The animal lure scent solution of claim 2, wherein said liquid scent is urine taken from a specie of the deer family.

4. The animal lure scent solution of claim 3, wherein the liquid urine is from a female doe.

5. The animal lure scent solution of claim 3, wherein the urine is from a male buck.

6. The animal lure scent solution of claim 3, wherein the urine is from a doe estrus.

7. The animal lure scent solution of claim 1, wherein said attractant scent is in the form of small particles of dirt or earth which has a non-offensive odor.

8. The animal lure scent solution of claim 1, wherein said attractant scent is in the form of small particles of dirt or earth which provides a cover-up scent including a cover for human scent.

9. The animal lure scent solution of claim 1, wherein the attractant scent is made from a fruit or a vegetable providing a non-offensive odor.

10. The animal lure scent solution of claim 9, wherein the fruit or vegetable scent utilized may be taken from corn, soy beans, pears, apples, carrots, sugar beets acorns and mulberries.

11. The animal lure scent solution of claim 1, wherein the scent provides a cover for humans thereby preventing the human scent from drifting into an area where the deer are located.

12. The animal lure scent solution of claim 1, said scent forming a cover-up for non-offensive odors and has a mild anus smell.

13. The animal lure scent solution of claim 2, wherein the attractant liquid scent also forms a cover-up which prevents the animal from sensing a human being and non-offensive odors.

14. An animal attractant scent dispenser comprising:
a container with an internally treaded entrance opening;
a threaded cap with a stem extending into said container, with said cap threaded onto said entrance opening;
and an animal lure scent solution contained within said container;
said solution comprising by volume approximately ⅓ of an attractant scent and approximately ⅔ by volume of a scentless liquid bubble soap which forms a carrier for said attractant scent when mixed with said carrier to form said solution;
said stem and said cap when removed from said container with said solution clinging to said stem and being released into the atmosphere by a person blowing air on the soap clinging to said stem, with the result that the bubbles carrying the attractant scent travel with the air flow and break on tree limbs, surrounding bushes, vegetations and the ground.

15. The animal attractant scent dispenser of claim 14, wherein said attractant scent is a liquid

16. The animal attractant scent dispenser of claim 14, wherein said liquid scent is urine taken from a specie of the deer family.

17. The animal attractant scent dispenser of claim 14, wherein the liquid urine of a female doe.

18. The animal attractant scent dispenser of claim 15, wherein the urine is from a male buck.

19. The animal attractant scent dispenser of claim 15, wherein the urine is taken from a doe estrus.

20. The animal attractant scent dispenser of claim 14, wherein said attractant scent is in the form of small particles of dirt or earth which has a non-offensive odor.

21. The animal attractant scent dispenser of claim 14, wherein said attractant scent is in the form of small particles of dirt or earth which provides a cover-up scent including a cover for human scent.

22. The animal attractant scent dispenser of claim 14, wherein the attractant scent is from a fruit or a vegetable providing a non-offensive odor.

23. The animal attractant scent dispenser of claim 22, wherein the fruit or vegetable utilized may be taken from corn, soy beans, apples, pears, carrots, sugar beets, acorns and mulberries.

24. The animal attractant scent dispenser of claim 14, wherein the scent provides a cover for humans thereby preventing the human scent from drifting into an area where the deer are located.

25. The animal attractant scent dispenser of claim 14, said scent forming a cover-up for non-offensive odors and has a mild anus smell.

26. The animal attractant scent dispenser of claim 15, wherein the attractant liquid scent also forms a cover-up which prevents the animal from sensing a human being and non-offensive odors.

27. A method for attracting a species of deer animal taken from the family including white tail deer, mule deer, elk, caribou and moose and utilizing a deer scent dispenser comprising a container with an externally threaded entrance opening, a threaded cap with a stem extending into said container, with said cap threaded onto said entrance opening, and an animal lure scent solution in said container comprising by volume ⅓ of an attractant scent and ⅔ of a scentless liquid bubble soap which forms a carrier for the attractant scent; the steps of removing the cap and stem from the container, with the solution clinging to the stem; and blowing air across the stem to form bubbles containing the attractant scent thereby dissipating the bubbles throughout the surrounding area where the bubbles travel with the air flow and lands on trees, bushes, vegetation and the ground where the bubbles burst to release the scent to the surrounding area for the purpose of attracting a specie of deer.
